(19) United States
(12) Patent Application Publication
(10) Pub. No.: US 2026/0331008 A1
(43) Pub. Date: Oct. 22, 2026

(54) Tractable Scroll Note Integrated with Blooming Apparatus

(71) Applicant: Tratasha Daneta Leno, Lauderhill, FL (US)

(72) Inventor: Tratasha Daneta Leno, Lauderhill, FL (US)

(21) Appl. No.: 19/182,374

(22) Filed: Apr. 17, 2025

Related U.S. Application Data
(60) Provisional application No. 63/568,324, filed on Mar. 21, 2024.

(51) Int. Cl. G09F 23/00; A41G 1/00

(52) U.S. Cl. CPC G09F 23/00; A41G 1/00

(57) ABSTRACT

An apparatus where an artificial flower with an articulated blooming operating mode which incorporates an integral stationery scroll for messages and/or images. The blooming action is operated by a twisting motion which controls the upper bloom through a grip or “knob” at the base of the central stem. The scroll is contained within the stem's tube structure and is linked to the blooming operation such that, when the flower is twisted into a bloomed position, the scroll is unfurled and vice versa. The blooming section may be arranged to appear similar to the petals of various flowers in various stages of blooming. The design aesthetics need not be limited to those found in nature, though it is inspired by them.

### FIELD OF THE INVENTION

The present invention relates generally to stationery and art paraphernalia. More specifically, the present invention is a scrolled sheet of paper integrated with a floral-style blooming art device.

### BACKGROUND OF THE INVENTION

The present invention, first, can be seen as a novel article of designer stationery. Scrolls of paper are a, sometimes popular, means of sending messages, particularly when combined with some artistic element. Further, short messages on various forms of stationery often accompany, contain, or serve as gifts to others. Small notes on paper can be a versatile means of communicating quick thoughts, details, or sentiment. Scrolls, particularly, have an interesting form, in that they can be placed within tubes and safely stored while taking up minimal space only to be unfurled and reveal a contained message, sometimes longer than expected from the space usage.

Flowers are another popular gift, including artificial flowers. Origami can be used to create impressive artistic recreation of the form of a flower. Plastic flowers can be used to provide some color and vibrancy of décor without the expiration dates associated with wilting plants. Across many artistic styles, flowers are a time-honored symbol which have been captured in, essentially, every conceivable medium. The use of artificial materials further enables one to utilize designs which, while inspired by nature, take on a more fantastic character.

The present invention is a floral-like arrangement that blossoms as the note scrolls open to display a message/photo/combination of both, like a greeting card. It is an objective of the present invention to improve the future use and display of greeting cards while adding a unique way of sharing these messages and/or pictures inside of the same. In addition, the present invention provides an alternative way to preserve messages and pictures with an artistic element.

### BRIEF DESCRIPTION OF THE DRAWINGS

FIG. 1 is an underside view for an embodiment of the present invention.

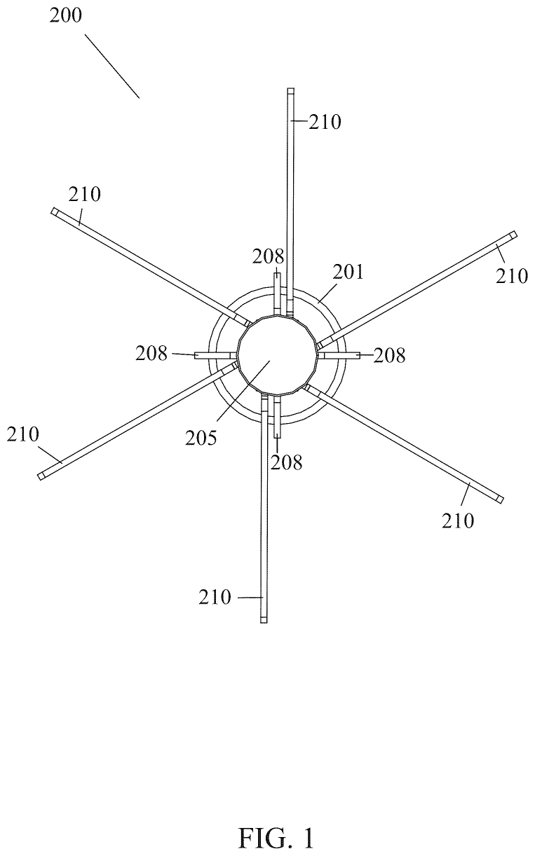

FIG. 2 is a side view for an embodiment of the present invention, showing the scroll's entry/egress location from the central tube.

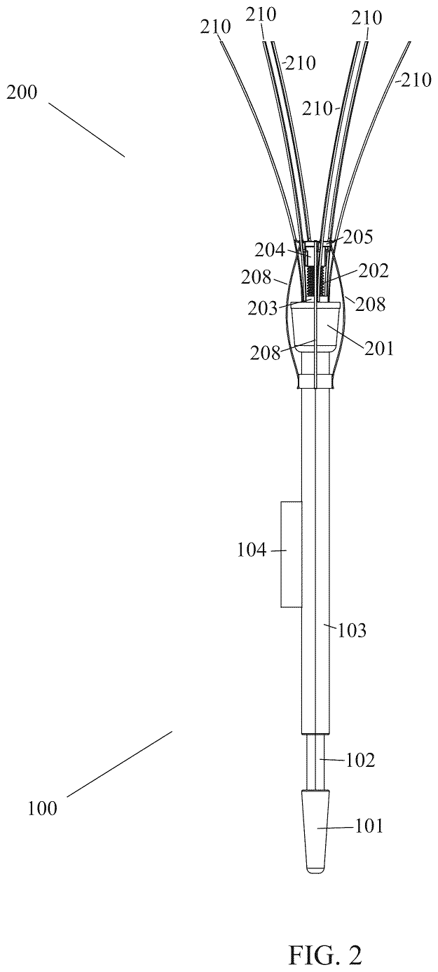

FIG. 3 is a rotated side view for an embodiment of the present invention.

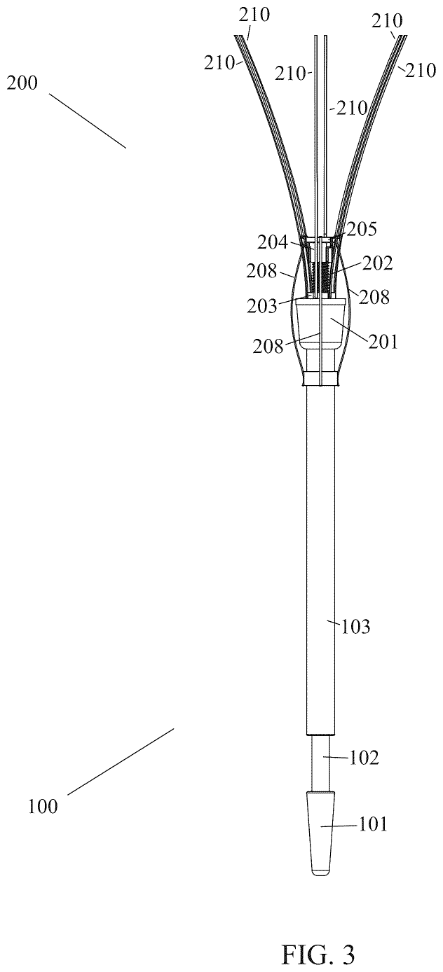

FIG. 4 is an overhead view for an embodiment of the present invention.

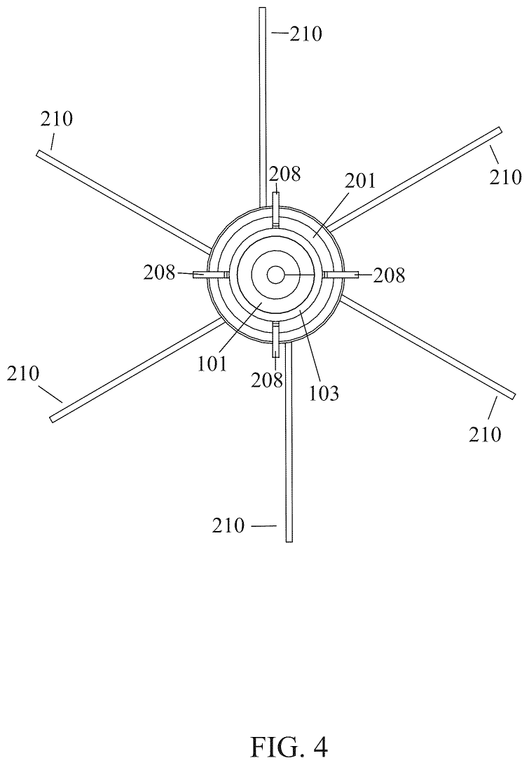

FIG. 5 is a front view for an embodiment of the present invention, showing the scroll's entry/egress location from the central tube.

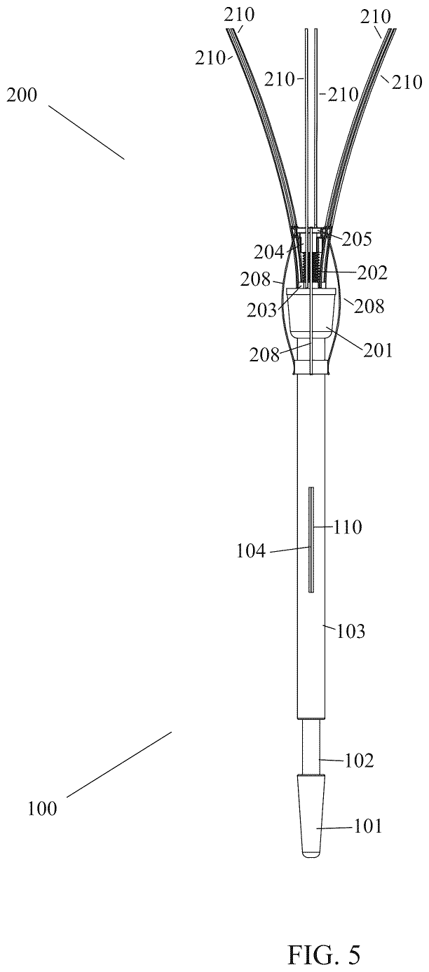

FIG. 6 is an overhead off-set view for an embodiment of the present invention.

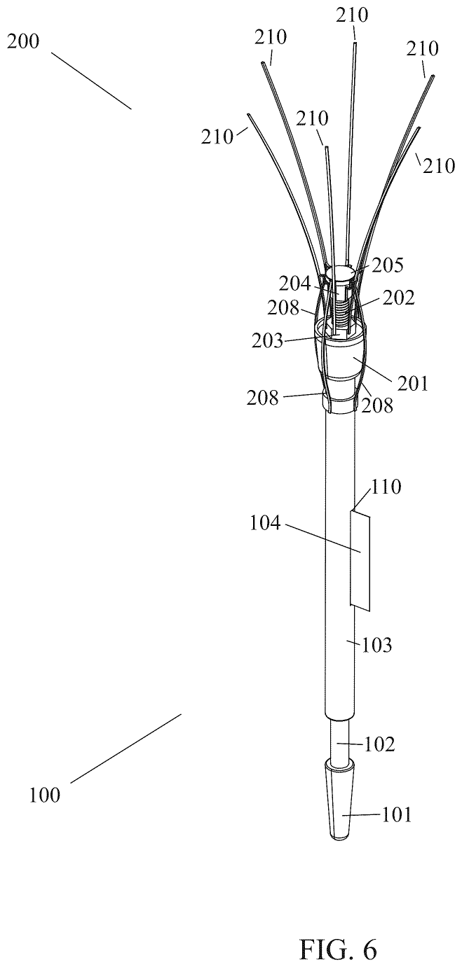

FIG. 7 is an underside off-set view for an embodiment of the present invention.

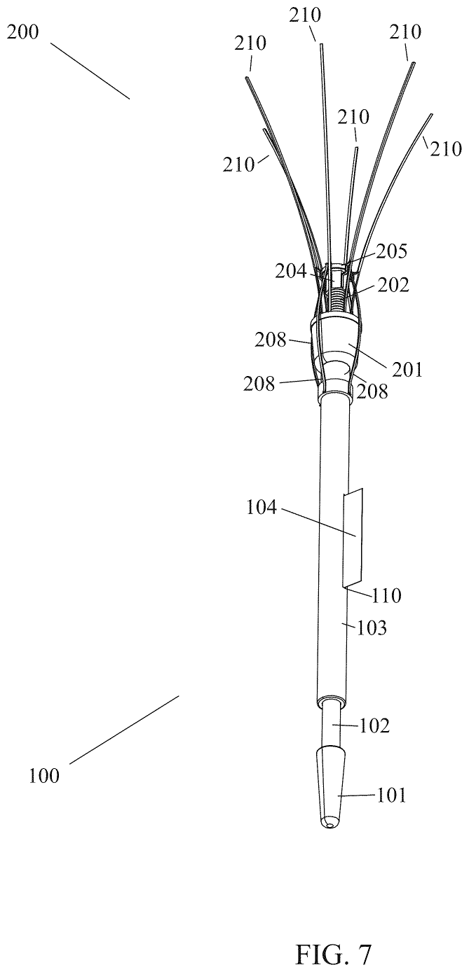

### DETAILED DESCRIPTIONS OF THE INVENTION

All illustrations of the drawings are for the purpose of describing selected versions of the present invention and are not intended to limit the scope of the present invention.

The present invention incorporates a stationery scroll within the stem structure of a device formed to approximate an artificial flower. The scroll serves to carry a greeting or other message. Photographs or small painted works could potentially be stored on the paper scroll in some embodiments. The article is arranged so that as the scroll is unfurled, the upper floral segment gives the appearance of a blooming flower. The furled-up scroll is contained within the tube structure of the main stem until unfurled. The device will generally allow for the scroll to be withdrawn into the tube after unfurling and will simultaneously revert the “blooming” state of the upper floral segment.

The present invention comprises a lower stem segment (100) and an upper floral segment (200). The lower stem segment (100) further comprises a base knob (101), a central rod (102), an outer shell (103), and a scroll of material (104). The upper floral segment (200) comprises a screw base (201), a central screw (202), a lower nut structure (203), a cap (204), a pin (205), three or more base attachment strands (208), and two or more petal strands (210). The upper floral segment is attached at the top end of the lower stem segment with multiple attachment points, described in greater detail below.

The lower stem segment (100) is constructed from its components by attaching the central rod (102) to the base knob (101) such that spinning or twisting the knob (101) will spin the rod (102) in conjunction. In various embodiments, the shape of the knob (101) is limited by its ability to effectively twist and will generally be formed such that it is easily twisted between two fingers. The outer shell (103) will generally be formed from a single material and must include a slot (110) through which the scroll (104) can be furled/unfurled. The scroll (104) is wrapped around the central rod (102) while the outer shell (103) envelopes the rod (102) scroll and scroll (104) combination while allowing the enveloped components (102, 104) to twist within the shell's tube structure (103). The scroll (104) is then pulled through the slot (110). In most embodiments, while withdrawn to its fullest extent into the outer shell (103), the scroll (104) will have a portion or attachment remain extended through the slot (110) to ensure that the scroll (104) will be guided through. This may take the form of a tab, attached pull-string, or similar additional component. For some embodiments, the tab will be incorporated into the aesthetic design of the device and take on the appearance of a leaf or other floral element. For some embodiments, the rod (102) and shell (103) may be constructed from flexible materials which still allow for the scroll (104) to have unimpeded access to the slot (110) and proper twist/unfurling action while the stem structure (100) is bent into different aesthetic positions. For example, access to the slot (110) could be maintained by extending its length or by reinforcing the section about which the scroll (104) is wrapped such that it remains inflexible. Different embodiments may allow for the scroll (104) to be constructed from any thin material conceivably allowing for the scrolling activity, such as parchment or thin metallic sheets. Further, various embodiments allow for the scroll to contain any conceivable images and/or messages.

The upper floral segment (200) is constructed as follows. The screw base (201) is affixed to the outer shell of the stem segment (103). The central screw (202) is affixed through the screw base (201) to the central rod (102) such that it turns in conjunction with the twisting/spinning motions of the central rod (102) and the spinning motion engages the screw effect from the combined screw base (201) and central screw (202). The lower nut structure (203) is aligned at a fixed position around the central screw (202). In various embodiments, the alignment may be achieved through adhesive, being a formed portion of the central screw, a combination of friction and mechanics, or other means of affixing a similar structure's position on a screw. The fixed position of the nut structure (203) serves to limit the range to which the screw (202) may be retracted into the screw base (201). Embodiments for the nut structure (203) need not be the traditional hexagonal or rectangular shapes common to nuts.

The cap (204) is placed at the top end of the central screw (202) and affixed to it by the pin (205) penetrating the cap (204) longitudinally into the central screw (202). This allows the cap (204) to maintain its rotational position independent of the screw (202) and other affixed structures while still being linked to the extension state of the screw (202). The cap (204) and outer shell (103) are connected by the three or more base attachment strands (208). The base attachment strands (208) are constructed from a semi-flexible material, such as wire or certain plastics, so as to reinforce the cap's (204) rotational independence from the screw (202). The strands (208) also serve to limit the extension of the overall structure. The two or more petal strands (210) are attached to both the lower nut structure (203) and the cap (204) while extending outward from both of them. The lower end of the strands (210) includes two segments for forming these attachment points which converge into a single route outward to a distal end at which petals or similar floral designs are attached. Each strand (210) is a singular component constructed from a flexible material (such as wire or certain plastics). In the preferred embodiments, the number of petal strands (210) will generally correlate to the number of petals needed to represent a given bloom aesthetic.

The blooming operation is realized because when lower nut structure (203) is retracted, the petal strands (210) are pulled tight in a twisting pattern around the central structure due to the rotationally stationary upper attachment to the cap (204) and the attachment to the lower nut (203). Embodiments allow for either rotational direction to be designated as the one which extends (unfurls) or withdraws (refurls) the screw structure. Embodiments may allow for the central rod (102) to be telescoping or otherwise account for the extension and retraction of the screw (202) to maintain certain aesthetic properties.

Although the invention has been explained in relation to its preferred embodiment, it is to be understood that many other possible modifications and variations can be made without departing from the spirit and scope of the invention.

1. A stationery apparatus comprising:
A lower stem segment comprising
a base knob;
a central rod;
an outer shell; and
a scroll of material;
and
an upper floral segment comprising
a screw base;
a central screw;
a lower nut structure;
a cap;
a pin;
three or more base attachment strands; and
two or more petal strands comprising a proximal endpoint, an intermediate endpoint near the proximal endpoint, and the remaining material converging to a single distal endpoint;
wherein
the base knob is affixed to the bottom of the central rod such that the knob and rod turn in conjunction about the same axis;
the scroll of material is affixed at one end to the central rod such that when the rod turns, the scroll will be wrapped about the rod;
the outer shell is a tube-like structure comprising a slotted opening longitudinally along its outside through which the scroll of material may pass;
the outer shell is placed to envelope the central rod and scroll such that the central rod and scroll may be turned within the outer shell;
the scroll of material is positioned along the central rod such that it will pass through the slotted opening of the outer shell as it is unfurled or refurled;
the screw base is affixed to the upper end of the outer shell, opposite the base knob;
the central screw is affixed longitudinally to the central rod such that turning the base knob and/or central rod will turn the screw in conjunction with the knob and rod;
the central screw is positioned such that, when it is turned, it will extend or retract from the screw base;
the lower nut structure is affixed along the central screw at a constant vertical and rotational relationship to the central screw at some point above the screw base;
the cap is placed at the top end of the central screw and the pin is inserted through the cap, affixed longitudinally to the central screw, and leaving the cap rotationally independent of the central screw;
the three or more attachment strands are affixed to the cap on one end and outside of the outer shell on the opposite end in an even distribution around the center; and
the two or more petal strands are each attached to the lower nut structure at the proximal endpoint, the cap at the intermediate endpoint, and the distal endpoint extending away from the attachment points.

2. The apparatus of claim 1, wherein the scroll of material comprises paper.

3. The apparatus of claim 2, wherein the paper is a photo paper material.

4. The apparatus of claim 2, wherein the paper is a parchment material.

5. The apparatus of claim 1, wherein the scroll of material comprises a foil metal sheet.

6. The apparatus of claim 1, wherein the central rod and outer shell are constructed from a flexible material allowing the stem segment to be placed in alternate shapes while maintaining the scrolls access to the slotted opening and turning functionality of the apparatus.

7. The apparatus of claim 1, wherein the central rod is a telescoping structure such that as the central screw is retracted into the screw base, the central rod retracts within itself and the base knob maintains a fixed vertically relative position.

8. The apparatus of claim 1, wherein the lower nut structure is affixed along the central screw using an adhesive material.

9. The apparatus of claim 1, wherein the cap is rotationally fixed relative to the outer shell by the attachment strands.

10. The apparatus of claim 9, wherein the attachment strands are constructed from metal wire material.

11. The apparatus of claim 9, wherein the attachment strands are constructed from flexible plastic material.

12. A stationery apparatus comprising:
A lower stem segment comprising
a base knob;
a central rod;
an outer shell; and
a scroll of material;
and
an upper floral segment comprising
a screw base;
a central screw comprising a lower screw structure, an intermediate nut structure, and an upper column formed continuously;
a cap;
a pin;
three or more base attachment strands; and
two or more petal strands comprising a proximal endpoint, an intermediate endpoint near the proximal endpoint, and the remaining material converging to a single distal endpoint;
wherein
the base knob is affixed to the bottom of the central rod such that the knob and rod turn in conjunction about the same axis;
the scroll of material is affixed at one end to the central rod such that when the rod turns, the scroll will be wrapped about the rod;
the outer shell is a tube-like structure comprising a slotted opening longitudinally along its outside through which the scroll of material may pass;
the outer shell is placed to envelope the central rod and scroll such that the central rod and scroll may be turned within the outer shell;
the scroll of material is positioned along the central rod such that it will pass through the slotted opening of the outer shell as it is unfurled or refurled;
the screw base is affixed to the upper end of the outer shell, opposite the base knob;
the central screw is affixed longitudinally to the central rod such that turning the base knob and/or central rod will turn the screw in conjunction with the knob and rod;
the central screw is positioned such that, when it is turned, the lower screw structure will extend or retract from the screw base;
the cap is placed at the top end of the central screw's upper column and the pin is inserted through the cap, affixed longitudinally to the upper column, and leaving the cap rotationally independent of the central screw;
the three or more attachment strands are affixed to the cap on one end and outside of the outer shell on the opposite end in an even distribution around the center; and
the two or more petal strands are each attached to the intermediate nut structure at the proximal endpoint, the cap at the intermediate endpoint, and the distal endpoint extending away from the attachment points

13. A stationery apparatus comprising:
A lower stem segment comprising
a base knob;
a central rod;
an outer shell; and
a scroll of material;
and
an upper floral segment comprising
a screw base;
a central screw;
a lower nut structure;
a cap;
a pin;
three or more base attachment strands;
two or more petal strands comprising a proximal endpoint, an intermediate endpoint near the proximal endpoint, and the remaining material converging to a single distal endpoint; and
two or more petals corresponding to the number of petal strands;
wherein
the base knob is affixed to the bottom of the central rod such that the knob and rod turn in conjunction about the same axis;
the scroll of material is affixed at one end to the central rod such that when the rod turns, the scroll will be wrapped about the rod;
the outer shell is a tube-like structure comprising a slotted opening longitudinally along its outside through which the scroll of material may pass;
the outer shell is placed to envelope the central rod and scroll such that the central rod and scroll may be turned within the outer shell;
the scroll of material is positioned along the central rod such that it will pass through the slotted opening of the outer shell as it is unfurled or refurled;
the screw base is affixed to the upper end of the outer shell, opposite the base knob;
the central screw is affixed longitudinally to the central rod such that turning the base knob and/or central rod will turn the screw in conjunction with the knob and rod;
the central screw is positioned such that, when it is turned, it will extend or retract from the screw base;
the lower nut structure is affixed along the central screw at a constant vertical and rotational relationship to the central screw at some point above the screw base;
the cap is placed at the top end of the central screw and the pin is inserted through the cap, affixed longitudinally to the central screw, and leaving the cap rotationally independent of the central screw;
the three or more attachment strands are affixed to the cap on one end and outside of the outer shell on the opposite end in an even distribution around the center;
the two or more petal strands are each attached to the lower nut structure at the proximal endpoint, the cap at the intermediate endpoint, and the distal endpoint extending away from the attachment points; and
the two or more petals are affixed about the distal endpoints of the petal strands in the form of a bloom structure.

14. The apparatus of claim 13, wherein the bloom structure is arranged to the form of a rose.

15. The apparatus of claim 13, wherein the bloom structure arranged to the form a carnation.

16. The apparatus of claim 13, wherein the bloom structure arranged to the form a tulip.
